(19) United States
(12) Patent Application Publication
(10) Pub. No.: US 2024/0250576 A1
(43) Pub. Date: Jul. 25, 2024

(54) TANGENTIAL JET COOLING FOR ELECTRIC MOTORS

(71) Applicants: Majed ETEMADI, Lasalle (CA); Corey Jerome KLINKHAMER, Windsor (CA); Ram BALACHANDAR, Windsor (CA); Ronald BARRON, Windsor (CA); Lakshmi Varaha IYER, Troy, MI (US); MAGNA INTERNATIONAL INC., Aurora (CA)

(72) Inventors: Majed ETEMADI, Lasalle (CA); Corey Jerome KLINKHAMER, Windsor (CA); Ram BALACHANDAR, Windsor (CA); Ronald BARRON, Windsor (CA); Lakshmi Varaha IYER, Troy, MI (US)

(21) Appl. No.: 18/290,369

(22) PCT Filed: May 12, 2022
(86) PCT No.: PCT/US2022/028953

§ 371 Date: Nov. 13, 2023

Related U.S. Application Data
(60) Provisional application No. 63/187,490, filed on May 12, 2021.

(51) Int. Cl. H02K 5/20

(52) U.S. Cl. CPC H02K 5/203

(57) ABSTRACT

An electric machine includes a stator, a rotor configured to rotate about an axis, and a housing surrounding the rotor and the stator. The housing includes an end cap at an axial end of the electric machine. The housing encloses an end space between the rotor and the end cap. The electric machine also includes a nozzle disposed within the end space and configured to discharge a cooling fluid into the end space in a direction tangential to the rotation of the rotor. The cooling fluid may include liquid, such as oil. The electric machine may be an induction machine or a synchronous machine. The nozzle may include an inlet tube that extends through the end cap. The electric machine may include two end spaces on opposite ends of the rotor, with one or more nozzles located in each of the two end spaces.

### CROSS-REFERENCE TO RELATED APPLICATIONS

This PCT International patent application claims the benefit of and priority to U.S. Provisional Patent Application Ser. No. 63/187,490 filed on May 12, 2021, and titled “Tangential Jet Cooling For Electronic Motors,” the entire disclosure of which is hereby incorporated by reference.

### FIELD

The present disclosure relates generally to cooling electric machines, such as electric motors.

### BACKGROUND

Several different techniques may be used for cooling electric machines, such as electric motors or motor/generators. For example, direct jet impingement may be used to directly cool stator end windings. The cooling system is capable of removing large heat loads from the stator windings by the formation of a very thin boundary layer along the windings due to the jet impingement. Integrating this cooling system towards cooling rotor windings may be problematic at high rotational speeds as the impinging jet can bend and deviate from the intended target as it enters a rotating frame. Furthermore, maintaining temperature uniformity throughout the stator windings is only possible with a large number of jets. A large number of jets can also create problems, since jet velocity can decrease with an increase in number of jets leading to reduced heat transfer performance.

Another technique for cooling electric machines includes shaft cooling, with a cooling system integrated in a motor shaft. Shaft cooling may enable compact packaging, wherein centrifugal forces push coolant through a hollow shaft. However, it is difficult to cool components sufficiently far from the shaft such stator lamination and windings with just shaft cooling. Transferring the cooling fluid from a stationary part to the rotating shaft can also be problematic in terms of cost and manufacturing.

Another technique for cooling electric machines includes fin or channel cooling, in which an array of fins or cooling air passages surround the stator. Offset plates may be used to disrupt cooling air flow to reduce boundary layer formation which aids in heat transfer performance. Fin or channel cooling can have some disadvantages, such as relatively large system pressure drop due to flow disturbance caused by the offset plates. Furthermore, incorporating channels and fluid flow to directly cool the rotor is complex.

### SUMMARY

The present disclosure provides an electric machine, including: a stator, a rotor configured to rotate about an axis, and a housing surrounding the rotor and the stator. The housing includes an end cap at an axial end of the electric machine. The housing encloses an end space between the rotor and the end cap. The electric machine also includes a nozzle disposed within the end space and configured to discharge a cooling fluid into the end space in a direction tangential to the rotation of the rotor.

### BRIEF DESCRIPTION OF THE DRAWINGS

Further details, features and advantages of designs of the invention result from the following description of embodiment examples in reference to the associated drawings.

FIG. 1 shows a cross-section of an electric machine including a tangential jet cooling system, in accordance with an aspect of the present disclosure.

FIG. 2 shows an enlarged view of a front nozzle of the tangential jet cooling system shown in FIG. 1.

FIG. 3 shows an enlarged view of a rear nozzle of the tangential jet cooling system shown in FIG. 1.

FIG. 4 shows a perspective view of a nozzle of the tangential jet cooling system shown in FIG. 1.

### DETAILED DESCRIPTION

Referring to the drawings, the present invention will be described in detail in view of following embodiments. The present disclosure provides for an electric machine, such as a motor or a motor/generator with tangential jet cooling.

The apparatus of the present disclosure may address and solve several different problems with conventional cooling of electric machines. For example, an electric machine that includes tangential jet cooling may resolve issues such as high rotor temperatures, poor temperature uniformity and high system pressure drop. Compared to a direct impinging jet, the tangential jet takes advantage of the presence of the rotational motion in a motor. The tangential jet may be expelled in the same direction as rotation, creating a high velocity swirling flow that will wet the rotor windings. Since rotation of the shaft dominates the velocity enhancement of the jet, a high flow rate for the tangential jets is not needed. Low jet flow rates along with the smooth bend of the elbow nozzles ensures low system pressure drop compared to channel cooling. Furthermore, the high velocity uniform swirling of the oil in the front and rear end space cools the windings evenly. The tangential jets are simple to implement as the nozzles can be directly attached to the end caps. Finally, very few parts and machining of components are needed for this invention compared to channel cooling and shaft cooling.

The tangential jet cooling system of the present disclosure can be applied to any motor winding type such as hairpin, random or concentrated winding. Moreover, the tangential jet cooling system of the present disclosure can be used for cooling various different types of electric machines, such as induction machines, permanent magnet machines and/or wound field synchronous machines.

According to an aspect of the disclosure, the tangential jet cooling system of the present disclosure provides for a jet of cooling fluid, such as a cooling liquid, to be expelled into an end space of the electric machine in a direction tangential to rotation of a rotor of the electric machine. According to an aspect of the disclosure, the tangential jet cooling system of the present disclosure includes one or more nozzles with elbow bends for directing the cooling fluid to the direction tangential to the rotation of the rotor. According to an aspect of the disclosure, the tangential jet cooling system of the present disclosure provides for enhanced jet velocity due to the rotation of the rotor in a same direction as the cooling fluid exiting the nozzles.

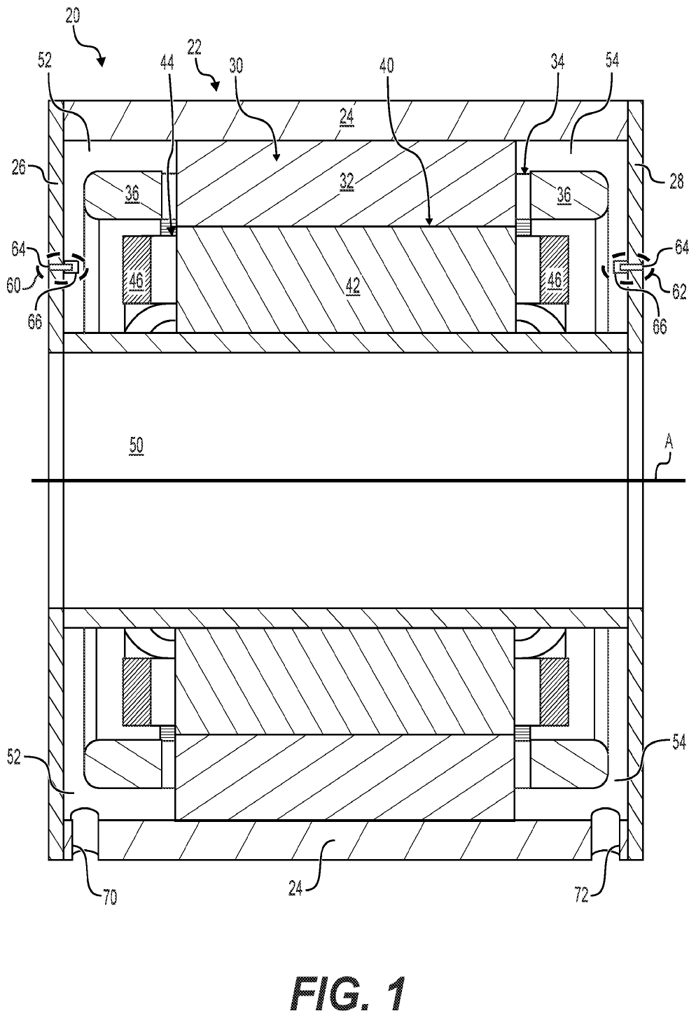

FIG. 1 shows a cross-section of an electric machine 20 having a tangential jet cooling system. Specifically, the electric machine 20 includes a housing 22 comprising a cylindrical side wall 24 and two end caps 26, 28, with each of the end caps 26, 28 disposed at opposite axial ends of the electric machine 20. The electric machine 20 may be configured to operate as an electric motor, a generator, or a motor/generator. The electric machine 20 may be, an induction machine or a synchronous machine, such as a permanent magnet synchronous machine (PMSM). The electric machine 20 includes a stator 30 configured to remain stationary, and a rotor 40 configured to rotate within the stator 30. The electric machine 20 also includes a rotor 40 configured to rotate about an axis A that is coaxial with the cylindrical side wall 24 of the housing 22. The electric machine 20 also includes shaft 50 fixed to rotate with the rotor 40 about the axis A. The shaft 50 extends through each of the end caps 26, 28. However, the shaft 50 may extend through only one of the two end caps 26, 28.

The stator 30 includes a stator lamination 32, which may include, for example, a plurality of laminated steel plates in a stacked arrangement. The stator 30 also includes a plurality of stator windings 34 wrapped through and/or around the stator lamination 32.

The rotor 40 includes a rotor lamination 42, which may include, for example, a plurality of laminated steel plates in a stacked arrangement. The rotor 40 also includes a plurality of rotor windings 44 wrapped through and/or around the rotor 40. Additionally or alternatively, the rotor 40 may include other structures, such as one or more permanent magnets.

A first end space 52 extends between the rotor lamination 42 and the first end cap 26. The first end space 52 also extends between the stator lamination 32 and the first end cap 26. A second end space 54 extends between the rotor lamination 42 and the second end cap 28. The second end space 54 also extends between the stator lamination 32 and the second end cap 28. Cooling fluid in either or both of the end spaces 52, 54 may contact the stator 30, for removing heat from the stator 30.

The stator windings 34 may extend into each of the end spaces 52, 54. For example, the stator windings 34 may include stator end turns 36, where the stator windings 34 loop around and change direction to form loops around the stator lamination 32. Additionally or alternatively, the rotor windings 44 may extend into each of the end spaces 52, 54. For example, the rotor windings 44 may include rotor end turns 46, where the rotor windings 44 loop around and change direction to form loops around the rotor lamination 42.

In some embodiments, and as shown in FIG. 1, the stator 30 is located radially outwardly from the rotor 40, and the rotor 40 is configured to fling the cooling fluid radially outwardly into contact with the stator 30. The cooling fluid contacting the stator 30 may then be warmed by the contact with the stator 30 to remove heat therefrom. For example, the rotor 40 may be configured so that cooling fluid is flung radially outwardly from the rotor end turns 46 and onto the stator end turns 36 in either or both of the end spaces 52, 54 to remove heat therefrom.

A first nozzle 60 is disposed within the first end space 52 and is configured to discharge a cooling fluid into the first end space 52 in a direction tangential to the rotation of the rotor 40. The first nozzle 60 may also be called a front nozzle 60. A second nozzle 62 is disposed with the second end space 54 and is configured to discharge the cooling fluid into the second end space 54 in a direction tangential to the rotation of the rotor 40. The second nozzle 62 may also be called a rear nozzle 62. The nozzles 60, 62 may be further configured to discharge the cooling fluid in a same direction as the rotation of the rotor 40. For example, and with reference to FIG. 1, if the rotor is rotating in a direction wherein the upper portion is moving into the sheet, the cooling fluid would be discharged from each of the nozzles 60, 62 in a direction into the sheet. Thus, the cooling fluid discharged from the nozzles 60, 62 may move in a same direction as any swirling fluid, such as gas, liquid, or a combination thereof, that is caused to rotate within the end spaces 52, 54 by rotation of the rotor 40. In some embodiments, the nozzles 60, 62 may direct the cooling fluid in a direction that is orthogonal to a cross-section of the electric machine 20 (i.e. orthogonal to the sheet).

The cooling fluid may include a liquid, such as an oil. In some embodiments, the cooling fluid may include automatic transmission fluid (ATF). The direction tangential to the rotation of the rotor 40, along which the cooling fluid is directed, may be partially or entirely tangential to an annular path traced by a point on the rotor 40 as the rotor 40 rotates about the axis A. In some embodiments, the direction tangential to the rotation of the rotor 40 is substantially tangential to the annular path traced by the point on the rotor 40 as the rotor 40 rotates about the axis A. In some embodiments, the direction tangential to the rotation of the rotor 40 is entirely tangential to the annular path traced by the point on the rotor 40 as the rotor 40 rotates about the axis A. In some embodiments, the cooling fluid may be directed tangential to a path that is parallel to and spaced apart from the annular path traced by the point on the rotor 40 as the rotor 40 rotates about the axis A. In some embodiments, the direction tangential to the rotation of the rotor 40 includes at least a component in an axial direction toward the rotor 40. In some embodiments, the direction tangential to the rotation of the rotor 40 includes at least a component in a radial direction toward or away from the axis A. The path of the cooling fluid may be deflected or otherwise influenced by air currents within the corresponding one of the end spaces 52, 54 after being discharged from the corresponding one of the nozzles 60, 62.

As shown in FIG. 1, each of the nozzles 60, 62 includes an inlet tube 64 that extends through a corresponding one of the end caps 26, 28 for receiving the cooling fluid. Each of the nozzles 60, 62 also includes a head portion 66 located within the corresponding one of the end spaces 52, 54, and which is configured to direct the cooling fluid to the desired direction, tangential to the rotation of the rotor 40.

As also shown in FIG. 1, the housing 22 defines a first outlet hole 70 for the cooling fluid to drain out of the first end space 52. The housing 22 also defines a second outlet hole 72 for the cooling fluid to drain out of the second end space 54. The outlet holes 70, 72 are shown as extending through the cylindrical side wall 24. The outlet holes 70, 72 may additionally or alternatively extend through one or both of the end caps 26, 28. In some embodiments, either or both of the outlet holes 70, 72 may be located at a lowest point of the corresponding end space 52, 54, below the shaft 50. Gravity may, therefore, aid in draining the cooling fluid out of the outlet holes 70, 72.

In some embodiments, the nozzles 60, 62 may be located at a top portion of each of the corresponding end spaces 52, 54, opposite from the corresponding outlet holes 70, 72. Alternatively or additionally, the nozzles 60, 62 may be located elsewhere in their corresponding end spaces 52, 54. For example, one or more of the nozzles 60, 62 may be located upstream of the top of the electric machine 20, directing the cooling fluid up and around the corresponding one of the end spaces 52, 54. In some embodiments, the electric machine 20 may include two or more of the nozzles 60, 62 in one of the end spaces 52, 54. One or both of the end spaces 52, 54 may include two or more nozzles 60, 62 spaced apart at regular circumferential intervals. For example, each of the end spaces 52, 54 may include three nozzles 60, 62 circumferentially spaced 120-degrees from one another.

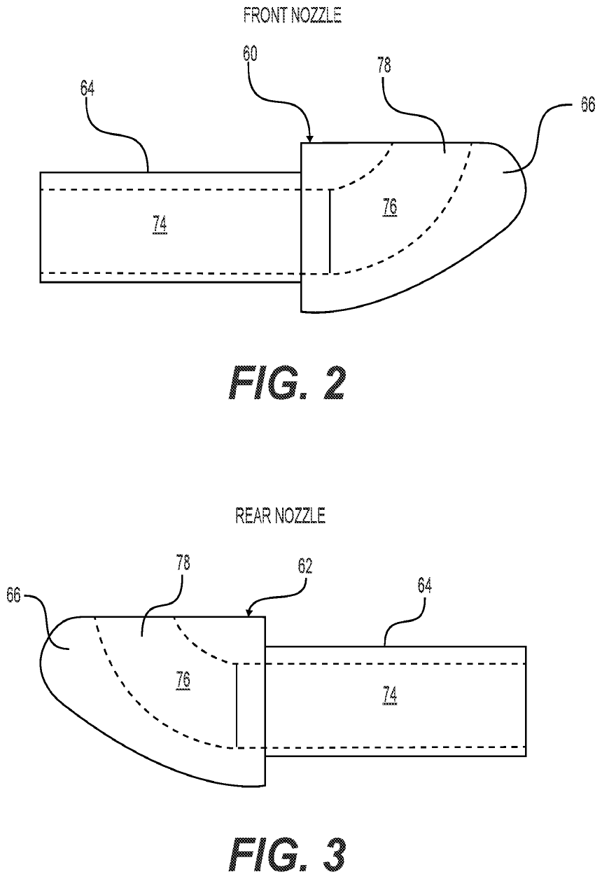

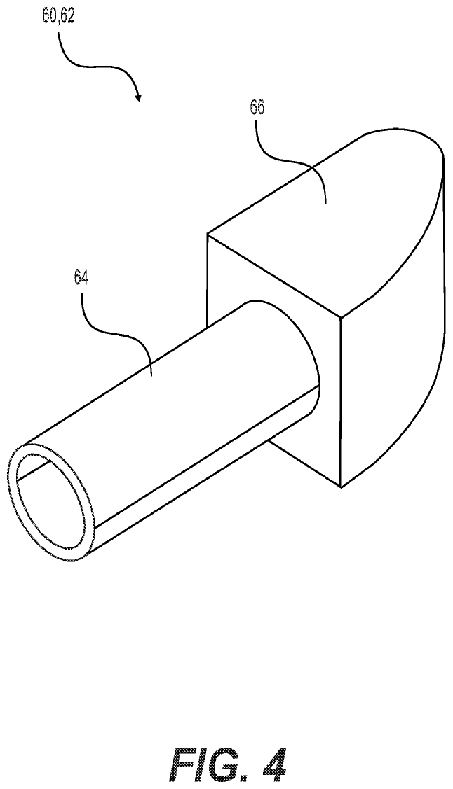

FIG. 2 shows an enlarged view of the first nozzle 60 of the tangential jet cooling system shown in FIG. 1. FIG. 3 shows an enlarged view of the second nozzle 62 of the tangential jet cooling system shown in FIG. 1. Each of the nozzles 60, 62 includes the inlet tube 64 and the head portion 66. The inlet tube 64 defines a linear flow passage 74 for conveying the cooling fluid to the head portion 66. The head portion 66 includes an elbow bend 76 configured to smoothly guide the cooling fluid in a 90-degree bend to be expelled tangentially into the corresponding one of the end spaces 52, 54. Each of the nozzles 60, 62 also includes the corresponding head portion 66 defining nozzle exit 78 from which the cooling fluid is discharged.

The smooth elbow bends may reduce the system pressure drop and hence the pumping power required for the cooling fluid circuit. As the cooling fluid is expelled from the nozzle exits 78, a jet may be formed with an enhanced velocity due to the prevailing rotational motion of fluid within the corresponding one of the end spaces 52, 54. The magnitude of the enhanced velocity may depend on the rotational speed of the shaft 50 and on a nozzle-to-shaft axial distance between the one of the nozzles 60, 62 and the shaft 50.

After being discharged from the nozzles 60, 62, cooling fluid may swirl around the shaft 50 and then wets the rotor windings 46 at a high velocity. The stator windings 36 may be directly cooled by cooling fluid splashed from the rotor windings 46 onto the stator windings 36.

The motor housing 22, including the cylindrical side wall 24 and the end caps 26, 28, enclose the internal components of the electric machine 20 such as the stator lamination 32, rotor lamination 42, stator windings 36, rotor windings 46, and the cooling fluid. The end caps 26, 28 may also be used to attach and support the nozzles 60, 62.

The present disclosure provides a cooling system for an electric machine 20 including nozzles 60, 62 with elbow bends 76 configured to direct the cooling fluid tangentially to a direction of rotation of the rotor 40. According to an aspect of the disclosure, this tangential discharge provide a positive utilization of prevailing rotational co-rotating fluid in the end spaces 52, 54. In other words, the cooling fluid discharged from the nozzles 60, 64 may be directed in a same direction as fluid, such as air, rotating in the end spaces 52, 54 by the motion of the rotor 40.

FIG. 4 shows a perspective view of a nozzle 60, 62 of the tangential jet cooling system.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An electric machine comprising:
a stator;
a rotor configured to rotate about an axis;
a housing surrounding the rotor and the stator and including an end cap at an axial end of the electric machine, the housing enclosing an end space between the rotor and the end cap; and
a nozzle disposed within the end space and configured to discharge a cooling fluid into the end space in a direction tangential to the rotation of the rotor, and
wherein the nozzle includes an inlet tube that extends through the end cap for receiving the cooling fluid.

2. The electric machine of claim 1, wherein the nozzle is further configured to discharge the cooling fluid in a same direction as the rotation of the rotor.

3. (canceled)

4. The electric machine of claim 1, wherein the nozzle includes an elbow bend for changing a direction of the cooling fluid prior to the cooling fluid exiting the nozzle.

5. The electric machine of claim 4, wherein the elbow bend is configured to change the direction of the fluid by 90-degrees.

6. The electric machine of claim 1, wherein the housing defines an outlet hole for the cooling fluid to drain out of the end space.

7. The electric machine of claim 6, wherein the outlet hole is located at a lowest point of the end space.

8. The electric machine of claim 1, wherein the end space extends around the stator, with the cooling fluid contacting the stator for removing heat therefrom.

9. The electric machine of claim 1, wherein the stator is located radially outwardly from the rotor; and wherein the rotor is configured to fling the cooling fluid radially outwardly into contact with the stator.

10. The electric machine of claim 1, wherein the rotor includes a rotor lamination and a plurality of rotor windings, with the end space extending between the rotor lamination and the end cap, and with the plurality of rotor windings extending into the end space.

11. The electric machine of claim 1, wherein the stator includes a stator lamination and a plurality of stator windings, with the end space extending between the stator lamination and the end cap, and with the plurality of stator windings extending into the end space.

12. The electric machine of claim 1, wherein the end cap is one of a pair of end caps, with each of the end caps disposed at opposite axial ends of the electric machine, and wherein the end space is one of a pair of end spaces, with each of the pair of end spaces located adjacent to corresponding ones of the pair of end caps;
wherein the nozzle is one of a pair of nozzles, with each nozzle of the pair of nozzles disposed within a corresponding one of the pair of end spaces.

13. The electric machine of claim 12, wherein each nozzle of the pair of nozzles includes a corresponding inlet tube that extends through a corresponding one of the pair of end caps for receiving the cooling fluid.

14. The electric machine of claim 1, wherein the stator includes a plurality of stator windings having stator end turns at least partially located circumferentially around the rotor, and the rotor is configured to fling the cooling fluid radially outwardly into contact with the stator end turns to remove heat therefrom.

15. The electric machine of claim 14, wherein the rotor includes a plurality of rotor windings and the stator end turns are at least partially located circumferentially around the plurality of rotor windings, and the rotor is configured to fling the cooling fluid radially outwardly from the rotor windings and into contact with the stator end turns to remove heat therefrom.

16. The electric machine of claim 1, wherein the rotation of the rotor causes a rotary movement of air within the end space, and
wherein the nozzle is configured to discharge the cooling fluid in a same direction as the rotary movement of the air within the end space.

17. The electric machine of claim 1, wherein the rotor traces an annular path as the rotor rotates about the axis, and
wherein the nozzle is configured to discharge the cooling fluid tangential to a path that is parallel to and spaced apart from the annular path traced by the rotor.

18. The electric machine of claim 1, wherein the direction tangential to the rotation of the rotor includes at least a component in an axial direction toward the rotor.

19. The electric machine of claim 1, wherein the direction tangential to the rotation of the rotor includes at least a component in a radial direction toward the axis.

20. The electric machine of claim 1, wherein the direction tangential to the rotation of the rotor includes at least a component in a radial direction away from the axis.
